(19) United States
(12) Patent Application Publication
(10) Pub. No.: US 2025/0135830 A1
(43) Pub. Date: May 1, 2025

(54) VEHICLE CONTROL APPARATUS AND SUSPENSION SYSTEM

(71) Applicant: Hitachi Astemo, Ltd., Hitachinaka-shi, Ibaraki (JP)

(72) Inventors: Yoshifumi KAWASAKI, Hitachinaka-shi, Ibaraki (JP); Makoto MATSUURA, Hitachinaka-shi, Ibaraki (JP); Ryusuke HIRAO, Hitachinaka-shi, Ibaraki (JP)

(21) Appl. No.: 18/730,109

(22) PCT Filed: Jan. 19, 2023
(86) PCT No.: PCT/JP2023/001473

§ 371 Date: Jul. 18, 2024

(30) Foreign Application Priority Data
Jan. 24, 2022 (JP) 2022-008595

(51) Int. Cl. B60G 17/06; B60G 17/0165

(52) U.S. Cl. CPC B60G 17/06; B60G 17/0165; B60G 2400/204; B60G 2400/821; B60G 2600/70

(57) ABSTRACT

A controller as a vehicle control apparatus controls a force (a damping force) of a shock absorber. A preview sensor detects road surface displacement information in a traveling direction of a vehicle. A vehicle speed sensor outputs vehicle speed information of the vehicle. The controller records the road surface displacement information into a memory for each predetermined distance by which the vehicle moves based on the vehicle speed information and a sampling time. The controller determines wheel position road surface displacement information corresponding to a position of the wheel based on the road surface displacement information recorded in the memory. The controller outputs an actuator instruction value for causing the shock absorber to perform a predetermined operation according to the wheel position road surface displacement information.

### TECHNICAL FIELD

The present disclosure relates to, for example, a vehicle control apparatus and a suspension system mounted on a vehicle such as an automobile.

### BACKGROUND ART

For example, PTL 1 discloses an active suspension control apparatus for a vehicle, which controls a force or a stroke of a suspension according to the running state of the vehicle. This active suspension control apparatus for the vehicle avoids considerable memory consumption when the vehicle runs at a low speed by thinning out sampled data according to the vehicle speed.

### CITATION LIST

### Patent Literature

PTL 1: Japanese Patent Application Laid-Open No. H4-342612

### SUMMARY OF INVENTION

### Technical Problem

According to the conventional technique, the consumed amount of the memory is reduced by lowering sampling granularity (data detailedness) in a pseudo-manner at the time of a low speed. Therefore, the suspension is supposed to be controlled with low granularity when the vehicle speed is increasing, and the performance of the active suspension may be impaired accordingly. As a result, the conventional technique makes it difficult to achieve both the securement of the performance (ride comfort and running stability) and a reduction in the consumed amount of the memory at the same time.

One of objects of the present invention is to provide a vehicle control apparatus and a suspension system capable of achieving both the “securement of the performance (ride comfort and running stability)” and a “reduction in the consumed amount of the memory” at the same time.

### Solution to Problem

According to one aspect of the present invention, a vehicle control apparatus is mounted on a vehicle. The vehicle includes an actuator apparatus provided between a vehicle body and a wheel of a vehicle and configured to change a force for suppressing a relative displacement between the vehicle body and the wheel, a road surface displacement detection portion configured to detect road surface displacement information in a traveling direction of the vehicle, and a vehicle speed information output portion configured to output vehicle speed information of the vehicle. The vehicle control apparatus is configured to control the actuator apparatus. The vehicle control apparatus includes a road surface displacement information reception portion configured to receive an input of the road surface displacement information, a vehicle speed information reception portion configured to receive an input of the vehicle speed information, and a memory configured to record the input road surface displacement information. The vehicle control apparatus records the road surface displacement information into the memory for each predetermined distance by which the vehicle moves based on the vehicle speed information and a sampling time and also determines wheel position road surface displacement information corresponding to a position of the wheel based on the road surface displacement information recorded in the memory, and outputs an actuator instruction value for causing the actuator apparatus to perform a predetermined operation according to the wheel position road surface displacement information.

Further, according to one aspect of the present invention, a suspension system includes an actuator apparatus provided between a vehicle body and a wheel of a vehicle and configured to change a force for suppressing a relative displacement between the vehicle body and the wheel, a road surface displacement detection portion configured to detect road surface displacement information in a traveling direction of the vehicle, a vehicle speed information output portion configured to output vehicle speed information of the vehicle, a memory configured to record the road surface displacement information, and a vehicle control apparatus configured to record the road surface displacement information into the memory for each predetermined distance by which the vehicle moves based on the vehicle speed information and a sampling time and also determine wheel position road surface displacement information corresponding to a position of the wheel based on the road surface displacement information recorded in the memory, and output an actuator instruction value for causing the actuator apparatus to perform a predetermined operation according to the wheel position road surface displacement information.

According to the one aspect of the present invention, both the “securement of the performance (ride comfort and running stability)” and a “reduction in the consumed amount of the memory” can be achieved at the same time.

### BRIEF DESCRIPTION OF DRAWINGS

FIG. 1 is an overall configuration diagram illustrating a four-wheeled automobile on which a vehicle control apparatus and a suspension system according to an embodiment are mounted.

FIG. 2 is a block diagram illustrating the vehicle control apparatus (an ECU), an actuator apparatus (a damping force variable damper), and the like illustrated in FIG. 1.

FIG. 3 is a diagram (a side view) illustrating the relationship among a vehicle, a road surface, and a preview sensor (a stereo camera).

FIG. 4 is a diagram (a plan view) illustrating the relationship between a wheel of the vehicle and a point of measurement by the preview sensor (the stereo camera).

FIG. 5 illustrates a characteristic line indicating one example of a change in a displacement of the vehicle over time according to the embodiment.

FIG. 6 is a block diagram illustrating a tire position road surface displacement calculation portion according to a modification.

FIG. 7 illustrates a characteristic line indicating one example of a change in the displacement of the vehicle over time according to a modification.

### DESCRIPTION OF EMBODIMENTS

In the following description, a vehicle control apparatus and a suspension system according to an embodiment will be described citing an example in which they are used for an automobile (more specifically, a four-wheeled automobile) as a vehicle with reference to the accompanying drawings.

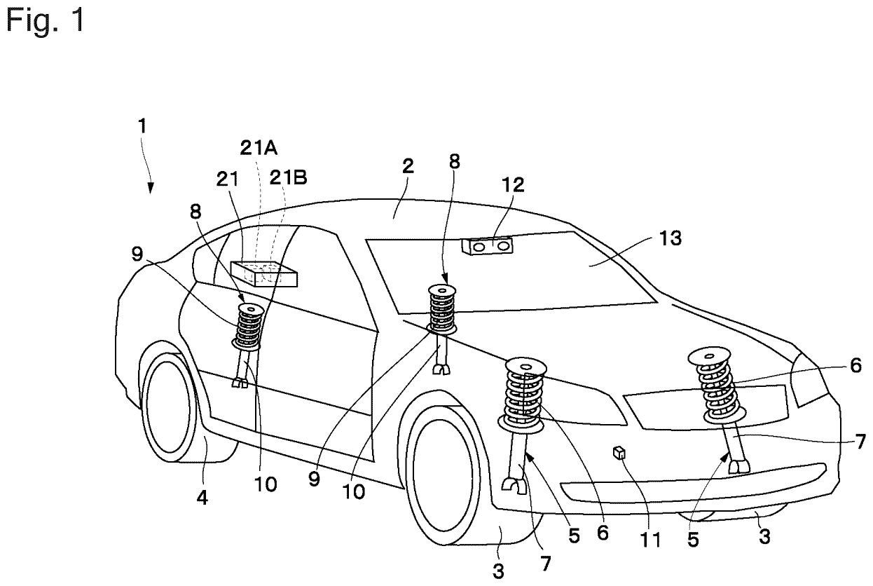

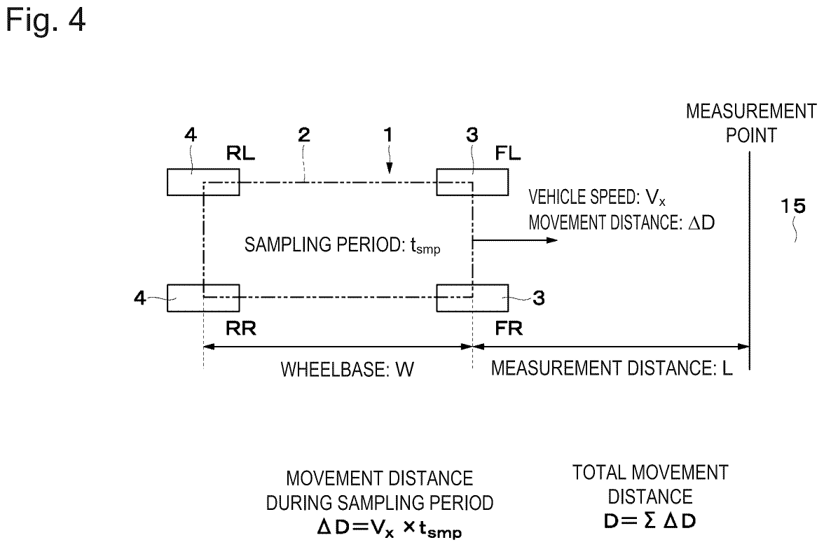

FIGS. 1 to 5 illustrate the embodiment. Referring to FIGS. 1 and 4, four wheels 3 and 4 in total, such as left and right front wheels 3 and left and right rear wheels 4, are disposed under a vehicle body 2 forming the main structure of a vehicle 1, which is an automobile. In FIG. 4, “FL”, “FR”, “RL”, and “RR” correspond to the positions of the wheels 3 and 4, respectively. As illustrated in FIG. 1, front wheel-side suspensions 5 and 5 (hereinafter referred to as front wheel suspensions 5) are disposed so as to be interposed between the left and right front wheels 3 and the vehicle body 2, respectively. The front wheel suspensions 5 each include a suspension spring 6 (hereinafter referred to as a spring 6) and a damping force adjustable shock absorber 7 (hereinafter referred to as a shock absorber 7) arranged in parallel with the spring 6.

Rear wheel-side suspensions 8 and 8 (hereinafter referred to as rear wheel suspensions 8) are disposed so as to be interposed between the left and right rear wheels 4 and the vehicle body 2, respectively. The rear wheel suspensions 8 each include a suspension spring 9 (hereinafter referred to as a spring 9) and a damping force adjustable shock absorber 10 (hereinafter referred to as a shock absorber 10) arranged in parallel with the spring 9. The shock absorbers 7 and 10 are each constituted by, for example, a semi-active damper serving as a hydraulic cylinder apparatus capable of adjusting a damping force (a damping force variable shock absorber). In other words, a semi-active suspension system using the damping force variable shock absorber is mounted on the vehicle 1.

Now, the shock absorbers 7 and 10 are provided between the vehicle body 2 and the wheels 3 and 4 of the vehicle 1, respectively. The shock absorbers 7 and 10 are each an actuator apparatus (a force generation mechanism) that changes a force for suppressing a relative displacement between the vehicle body 2 and the wheel 3 or 4. More specifically, the shock absorbers 7 and 10 are each a damping force variable-type damping force generation apparatus (a damping force variable shock absorber). The characteristic of the damping force generated by each of the shock absorbers 7 and 10 (a damping force characteristic) is variably controlled by a controller 21, which will be described below. To fulfill that, the shock absorbers 7 and 10 are each equipped with a damping force adjustment device (not illustrated) constituted by a damping force adjustment valve and a solenoid or the like to adjust the damping force characteristic from a hard characteristic (a high characteristic) to a soft characteristic (a low characteristic) continuously (or in a multi-step manner). The damping force characteristic of each of the shock absorbers 7 and 10 is variably adjusted according to an instruction electric current (a control signal) supplied from the controller 21 to the damping force adjustment device.

A conventionally known structure, such as a pressure control method that controls a pilot pressure of a damping force generation valve or a flow rate control method that controls a passage area, can be used as the damping force adjustment valve. Alternatively, each of the shock absorbers 7 and 10 is not limited to the above-described example as long as it can adjust the damping force continuously (or in a multi-step manner), and may be an actuator apparatus (a force generation mechanism) such as a pneumatic damper, an electromagnetic damper, an electrorheological fluid damper (an ER damper), or a magnetic fluid damper. Alternatively, each of the shock absorbers 7 and 10 may be an actuator apparatus (a force generation mechanism) such as an air damper (an air suspension) using an air spring (a pneumatic spring), a hydraulic damper in which front left and right, and rear left and right hydraulic cylinders are connected via pipes, or a stabilizer that provides a force to motions of left and right wheels.

Further alternatively, each of the shock absorbers 7 and 10 may be an actuator apparatus (a force generation mechanism) capable of generating a thrust force. i.e., a full-active damper constituted by a hydraulic actuator, an electric actuator, or an atmospheric actuator. In other words, a full-active suspension system using the full-active damper may be mounted on the vehicle 1. In sum, each of the shock absorbers 7 and 10 is an actuator apparatus (a force generation mechanism) capable of adjusting the force generated between the vehicle body 2 side and the wheel 3 and 4 side of the vehicle 1, and can be realized by employing any of various kinds of actuator apparatuses (force generation mechanisms) such as a damping force variable hydraulic damper, an electrorheological fluid damper, a pneumatic damper, an electromagnetic damper, a hydraulic actuator, an electric actuator, and an atmospheric (pneumatic) actuator.

Next, sensors 11 and 12 mounted on the vehicle 1 will be described.

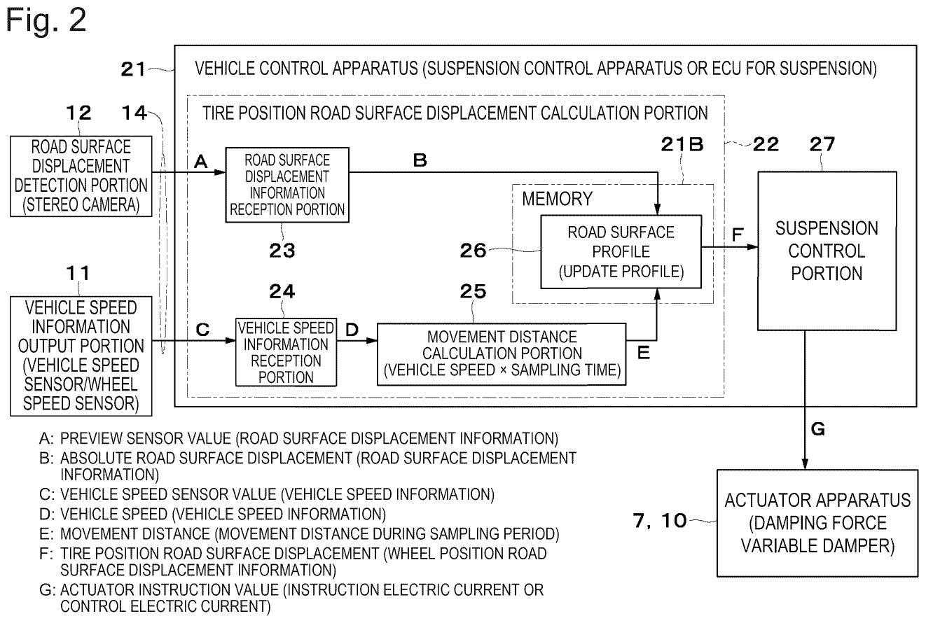

As illustrated in FIG. 1 to FIG. 3, a vehicle speed sensor 11 and a preview sensor 12 are mounted on the vehicle 1. In other words, the vehicle 1 includes the vehicle speed sensor 11 and the preview sensor 12 in addition to the shock absorbers 7 and 10. The vehicle speed sensor 11 is provided on, for example, an output shaft (not illustrated) of a transmission mounted on the vehicle 1. The vehicle speed sensor 11 detects a vehicle speed (a vehicle velocity), which is the speed of the vehicle 1. Vehicle speed information, which is a value detected by the vehicle speed sensor 11 (a signal corresponding to the vehicle speed), is output to, for example, various kinds of controllers (ECUs) mounted on the vehicle via a CAN 14 (FIG. 2), which is in-vehicle LAN communication. For example, the information of the vehicle speed sensor 11 (the vehicle speed information) is output to the controller 21 (an ECU for the suspension) of the suspension system via the CAN 14 as illustrated in FIG. 2.

The vehicle speed sensor 11 corresponds to a vehicle speed information output portion that outputs the vehicle speed information of the vehicle 1. The vehicle speed can also be calculated based on, for example, detection information (a signal corresponding to a wheel speed) of a wheel speed sensor (not illustrated) that detects the rotational speed of the wheel 3 or 4. Therefore, the vehicle speed information output portion may be formed by the wheel speed sensor. In other words, the vehicle speed information output portion may be a sensor (a detector) that directly detects a state amount corresponding to the vehicle speed, such as the vehicle speed sensor 11, or may be a sensor (a detector) that detects a state amount corresponding to the vehicle speed, such as the wheel speed sensor. Further alternatively, the vehicle speed information output portion may be a vehicle speed estimation portion (an arithmetic device) that estimates the vehicle speed based on various kinds of state amounts of the vehicle.

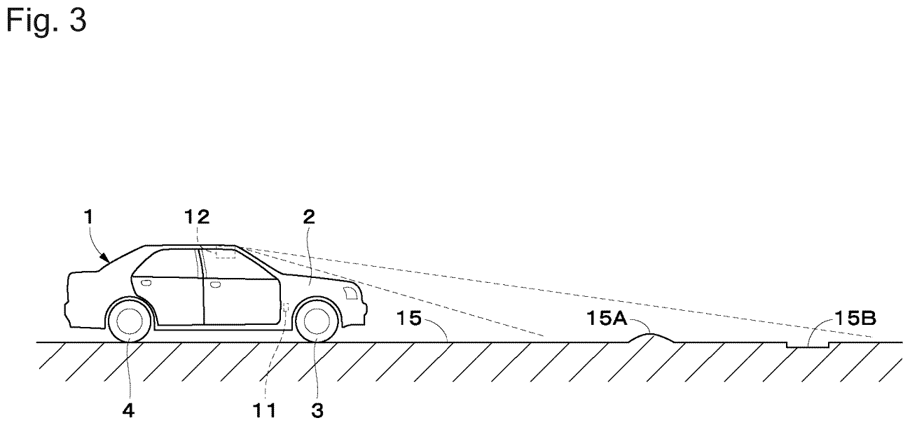

The preview sensor 12 is provided at, for example, the central position in the lateral direction of the vehicle 1 on the upper side of a windshield 13 of the vehicle 1. The preview sensor 12 may be provided on a front grille, a front bumper, or the like of the vehicle 1. In other words, the preview sensor 12 is provided on the front side of the vehicle 1. As illustrated in FIGS. 3 and 4, the preview sensor 12 measures a state of a road surface 15 (a vertical displacement of the road surface 15) lying ahead of the vehicle 1. The preview sensor 12 corresponds to a road surface detection portion (a road surface displacement detection portion) that detects road surface information (more specifically, road surface displacement information) in a traveling direction of the vehicle 1. In the embodiment, a stereo camera is used as the preview sensor 12, which serves as the road surface displacement detection portion. The road surface displacement detection portion detects the vertical displacement of the road surface 15.

Then, the road surface displacement detection portion corresponds to an external world perception sensor, and can be realized using a camera such as a stereo camera or a single camera (for example, a digital camera), and/or a radar such as a laser radar, an infrared radar, or a millimeter-wave radar (for example, a light emitting element such as a semiconductor radar and a light receiving element that receives it), a lidar (LiDAR), or a sonar. The road surface displacement detection portion (the external world perception sensor) is not limited to the camera, the radar, the lidar, and the sonar, and can be realized using any of various kinds of sensors (a detector, a meter, and a radiodetector) capable of perceiving (detecting) the displacement of the road surface 15 (a road surface state) in the traveling direction of the vehicle 1.

Next, the controller 21, which controls the shock absorbers 7 and 10, will be described with reference to FIGS. 1 and 2.

The controller 21 is mounted on the vehicle 1. The controller 21 is, for example, a control apparatus that includes a microcomputer, a power source circuit, and a driving circuit. The controller 21 is also called an ECU (Electronic Control Unit). The controller 21 is a vehicle control apparatus that controls the vehicle 1, more specifically, a suspension control apparatus that controls a vibration and/or a pose of the vehicle 1 (i.e., a control apparatus for the suspension system, an ECU for the suspension, or an ECU for the shock absorber). The controller 21 controls each of the shock absorbers 7 and 10 (adjusts the damping force thereof) based on the information detected (measured) by the sensor 11, 12, and/or the like (the detected value or the measured value), or estimated (calculated) information (an estimated value, a calculated value, or a computed value). In other words, the controller 21 controls the force (the damping force) of each of the shock absorbers 7 and 10, which are actuator apparatuses.

To fulfill this function, the input side of the controller 21 is connected to the sensors 11 and 12. The signal corresponding to the vehicle speed detected by the vehicle speed sensor 11 (the vehicle speed information), the signal corresponding to the road surface displacement detected by the preview sensor 12 (the road surface displacement information), and the like are input to the controller 21. On the other hand, the output side of the controller 21 is connected to the shock absorbers 7 and 10, which are control dampers. The controller 21 outputs the control signal (the instruction electric current) to the damping force adjustment device of each of the shock absorbers 7 and 10 (for example, the solenoid that adjusts the valve-opening pressure of the damping force adjustment valve).

The controller 21 includes a control portion 21A (illustrated only in FIG. 1), which performs arithmetic processing, such as a CPU (a central processing unit), and a memory 21B, which is a storage portion, such as a ROM, a RAM, or a nonvolatile memory. The memory 21B stores therein, for example, a processing program for computing (calculating) a road surface displacement at a position where each of the wheels 3 and 4 passes through (the position of each of the shock absorbers 7 and 10) based on the information (the input signal) from each of the sensors 11 and 12. Further, the memory 21B also stores therein a processing program for calculating the damping force that should be generated by each of the shock absorbers 7 and 10 based on the road surface displacement at the position where each of the wheels 3 and 4 passes through (the position of each of the shock absorbers 7 and 10), a processing program for outputting the control signal corresponding to the damping force that should be generated, and the like.

For example, the skyhook control law, the BLQ control law (the bilinear optimal control law), or the H∞ control law can be used as a control law that calculates the damping force of each of the shock absorbers 7 and 10 (a control law for ride comfort and a control law for handling stability). The controller 21, for example, increases the damping force of each of the shock absorbers 7 and 10 when decelerating the motion (the behavior) of the vehicle body 2 located on the sprung side with the aid of the damping force of each of the shock absorbers 7 and 10, and suppresses the damping force of each of the shock absorbers 7 and 10 when accelerating the motion (the behavior) of the vehicle body 2 located on the sprung side with the aid of the damping force of each of the shock absorbers 7 and 10. Each of the shock absorbers 7 and 10, which are damping force variable dampers, works to change the damping force to appropriately damp a vertical motion of each of the wheels 3 and 4, thereby suppressing the vibration of the vehicle body 2.

On the other hand, as a technique for controlling a suspension, there has been developed a preview control suspension that detects a displacement of a road surface in advance using a preview sensor such as a camera and controls the suspension according to this detected displacement of the road surface. This case necessitates an adjustment of a timing of outputting the detected road surface displacement information as control information. In other words, this technique necessitates an adjustment for handling the detected road surface displacement information as an input of the suspension control at the timing when the wheel (the tire) passes through. One conceivable method therefor is, for example, to adjust the timing by calculating an arrival time based on the distance to the detected road surface and the vehicle speed.

However, in this case, when the vehicle runs at a low vehicle speed, a long time may be taken to reach the detected position, and the memory consumption may considerably increase. This will be more specifically described, supposing that the vehicle runs on the road surface 15 having unevenness such as a bump 15A, a pot hole 15B, and the like where the preview control likely becomes highly effective as illustrated in FIG. 3. When running on the road surface 15 conditioned in this manner at a low speed, a large amount of data may be stored and the memory may be considerably consumed due to an increase in the time (the arrival time) since when the road surface displacement is detected until the shock absorber of the control target wheel reaches there.

On the other hand, the above-described active suspension control apparatus for the vehicle disclosed in PTL 1 is configured to avoid considerable memory consumption when the vehicle runs at a low speed by thinning out sampled data according to the vehicle speed. However, according to this technique, sampling granularity (data detailedness) is lowered in a pseudo-manner at the time of a low speed, and therefore the suspension is supposed to be controlled with low granularity when the vehicle speed is increasing. As a result, the performance of the active suspension may be impaired.

In light thereof, in the embodiment, the distance and the displacement information are stored in the memory 21B of the controller 21 in association with each other. In other words, each time the vehicle 1 moves by a predetermined distance, displacement information for this distance is recorded into the memory 21B. This allows the interval of the displacement information (the granularity of the distance) to be determined in advance at a design stage. As a result, the data (the displacement information) can be stored at granularity kept constant from a low speed to a high speed, and therefore the impairment of the performance can be prevented while the consumed amount of the memory 21B is reduced.

In other words, in the embodiment, the displacement information and the output timing can be stored in the memory 21B while the memory consumed amount is saved even at the time of a low speed by storing the distance and the displacement information in association with each other. Further, the embodiment eliminates the necessity of processing for converting the input information acquired from the camera that outputs spatial information (the distance and the road surface displacement), i.e., the preview sensor 12 into time. As a result, error generation due to the simplification of the processing and the conversion can also be prevented. In the following description, the details thereof will be described.

FIG. 2 illustrates a control block diagram of the controller 21 when the stereo camera is used as the preview sensor 12. FIGS. 3 and 4 illustrate the positional relationship between the vehicle 1 running on the road surface 15 and a measurement position (a measurement point) of the preview sensor 12. Then, the following table 1 indicates a basic concept of the storage of the road surface displacement information associated with the distance.

TABLE 1

| LEFT (L) | | RIGHT (R) | |
|---|---|---|---|
| DISTANCE | DISPLACEMENT | DISTANCE | DISPLACEMENT |
| 0 | ZO_{L1} | 0 | ZO_{R1} |
| D1 | ZO_{L2} | D1 | ZO_{R2} |
| . | . | . | . |
| . | . | . | . |
| . | . | . | . |
| D2 | ZO_{L3} | D2 | ZO_{R3} |

In the embodiment, a “displacement” measured by the preview sensor 12 and a “distance” corresponding to this measured position are stored in the memory 21B inside the controller 21 as indicated in the table 1. In this case, the “displacement” corresponds to, for example, the vertical displacement of the road surface 15 (the road surface displacement information). Further, the “distance” corresponds to, for example, a distance by which the vehicle 1 moves from a reference position (for example, a distance 0) (movement distance information). In this case, the reference position (the distance 0) can be a position serving as a reference for the distance when the displacement is recorded, such as the position of the measurement point when the measurement is started. Then, assume that tₛₘₚ represents a control period (a sampling period or a sampling time) of the controller 21, and Vx represents the vehicle speed of the vehicle 1. Further, assume that Ds represents a predetermined distance set in the memory 21B. i.e., a distance interval (distance granularity) at which the road surface displacement information is stored into the memory 21B.

For example, in the previous control period, a distance D1 and road surface displacement information ZO_{L2} and ZO_{R2} at this time are stored into the memory 21B, as indicated in the table 1. In the next control period, the distance in the memory 21B is shifted by a movement distance ΔD (=Vx×tₛₘₚ) of the vehicle 1, and a new measured value (road surface displacement information) acquired by the preview sensor 12 is read into the memory 21B. At this time, if the movement distance ΔD during one control period is short and is equal to or shorter than the predetermined distance Ds set in the memory 21B, the vehicle 1 is determined not to move, and the measured value is overwritten with the newly read measured value (road surface displacement information). The predetermined distance Ds is assumed to be Ds=D2−D1.

Then, the measured value is repeatedly overwritten until the total movement distance D (=ΣΔD) of the vehicle 1 reaches the predetermined distance Ds set in the memory 21B, and the measured value (the road surface displacement information) when the total movement distance D reaches the predetermined distance Ds (or immediately before the total movement distance D reaches the predetermined distance) is stored (recorded) into the memory 21B. In other words, when the vehicle 1 reaches the distance D2 located more ahead of the distance D1 by the predetermined distance Ds, the distance D2 and road surface displacement information ZO_{L3} and ZO_{R3} at this time are stored into the memory 21B, as indicated in the table 1. The measured value acquired between D1 and D2 is overwritten (deleted) as indicated with “⋅” in the table 1. In other words, the measured value is overwritten (the previous information is deleted) when the vehicle 1 does not move by the predetermined distance Ds.

Then, the measured value (the road surface displacement information) for each predetermined distance Ds stored in the memory 21B is used for the suspension control as a control input value at the position of the front wheel 3 when the vehicle 1 moves by a distance L from the measurement point. As illustrated in FIG. 4, a distance L is a distance between the measurement point and the front wheel 3 (a measurement distance L). Further, the measured value (the road surface displacement information) stored in the memory 21B is used for the suspension control as a control input value at the position of the rear wheel 4 when the vehicle 1 moves by a distance equivalent to the distance L+a wheelbase W from the measurement point. The measured value (the road surface displacement information) already used for the suspension control can be deleted from the memory 21B.

On the other hand, when running at a high speed, the movement distance ΔD during one control period increases. For example, when the vehicle 1 runs at a high speed, the vehicle 1 may move by a distance several times as long as the predetermined distance Ds during one control period. In this case, the road surface displacement information is interpolated based on the road surface displacement information in a period where this information can be read. For example, the road surface displacement information is linearly interpolated based on the road surface displacement information in the previous control period and the road surface displacement information in the present control period. This will be more specifically described, supposing that the movement distance ΔD during one control period is twice as long as the predetermined distance Ds (ΔD=2Ds).

In this case, assume that D1 and ZO_{L2} and ZO_{R2} represent the distance and the road surface displacement information (the vertical displacement) in the previous control period, respectively, D3 (=D1+2Ds) and ZO_{L4} and ZO_{R4} represent the distance and the road surface displacement information (the vertical displacement) in the present control period, respectively, and ZO_{L3} and ZO_{R3} represent the road surface displacement information (the vertical displacement) at the distance D2 located at the midpoint between the distance D1 and the distance D3. The road surface displacement information ZO_{L3} and ZO_{R3} at the distance D2 can be determined in the following manner. That is, the road surface displacement information on the left side of the vehicle 1 at the distance D2 can be calculated as ZO_{L3}=(ZO_{L4}+ZO_{L2)}/2, and the road surface displacement information on the right side of the vehicle 1 at the distance D2 can be calculated as ZO_{R3}=(ZO_{R4}+ZO_{R2})/2. In this case, the road surface displacement information stored in the memory 21B can also be used for the suspension control as the control input value at the position of each of the wheels 3 and 4 when the vehicle 1 moves by the distance L and/or by the distance equivalent to the distance L+the wheelbase W from the measurement point. The measured value (the road surface displacement information) already used for the suspension control can be deleted from the memory 21B.

For example, suppose that the control period (a sampling frequency) is 1 ms, and the predetermined distance Ds stored in the memory 21B (profile granularity) is 1 cm. In this case, when running at 10 km/h (=2.78 m/s=278 cm/s), which means low-speed running, the vehicle 1 advances by approximately 0.28 cm every time one control period elapses. Therefore, every time four control periods elapse, the road surface displacement information at this moment is stored. In other words, the road surface displacement information in approximately three control periods spent until the vehicle 1 advances by 1 cm, which is the predetermined distance, is deleted by being overwritten. On the other hand, when running at 100 km/h, which means high-speed running, the vehicle 1 advances by approximately 2.8 cm every time one control period elapses. In this case, the road surface displacement information during one control period is interpolated (for example, linearly interpolated) based on the road surface displacement information in the previous control period and the road surface displacement information in the present control period.

To realize such control, the controller 21 as the vehicle control apparatus (the suspension control apparatus) is connected to the vehicle speed sensor 11 corresponding to the vehicle speed information output portion and the preview sensor 12 corresponding to the road surface displacement detection portion as illustrated in FIG. 2. The controller 21 controls the shock absorbers 7 and 10, which are damping force variable dampers, based on the detection signals of the vehicle speed sensor 11 and the preview sensor 12 (the vehicle speed information and the road surface displacement information). The controller 21 includes a tire position road surface displacement calculation portion 22 and a suspension control portion 27.

The vehicle speed sensor value (the vehicle speed information) acquired from the vehicle speed sensor 11 and the preview sensor value (the road surface displacement information) acquired from the preview sensor 12 are input to the tire position road surface displacement calculation portion 22. The tire position road surface displacement calculation portion 22 calculates the displacement of the road surface 15 at the position of each of the wheels 3 and 4, i.e., a tire position road surface displacement (wheel position road surface displacement information) based on the vehicle speed sensor value (the vehicle speed information) and the preview sensor value (the road surface displacement information). The tire position road surface displacement calculation portion 22 outputs the calculated tire position road surface displacement (the wheel position road surface displacement information) to the suspension control portion 27.

The tire position road surface displacement calculation portion 22 of the controller 21 includes a road surface displacement information reception portion 23, a vehicle speed information reception portion 24, and the memory 21B. Further, the tire position road surface displacement calculation portion 22 includes a movement distance calculation portion 25. The preview sensor value corresponding to the road surface displacement information detected by the preview sensor 12 is input to the road surface displacement information reception portion 23. The road surface displacement information reception portion 23 outputs an absolute road surface displacement (a signal corresponding to the absolute road surface displacement) corresponding to the road surface displacement information based on the input preview sensor value to the memory 21B, more specifically, a road surface profile portion 26 of the memory 21B.

The vehicle speed sensor value corresponding to the vehicle speed information detected by the vehicle speed sensor 11 is input to the vehicle speed information reception portion 24. The vehicle speed information reception portion 24 outputs the vehicle speed (the signal corresponding to the vehicle speed) corresponding to the vehicle speed information to the movement distance calculation portion 25 based on the input vehicle speed sensor value. The vehicle speed is input from the vehicle speed information reception portion 24 to the movement distance calculation portion 25. The movement distance calculation portion 25 calculates the movement distance of the vehicle 1, i.e., the movement distance during one control period based on the vehicle speed and the control period (the sampling time). In other words, the movement distance calculation portion 25 calculates the distance by which the vehicle 1 moves during one control period by multiplying the vehicle speed by the control period (the sampling time). The movement distance calculation portion 25 outputs the calculated movement distance during one control period (a signal corresponding to the movement distance) to the memory 21B, more specifically, the road surface profile portion 26 of the memory 21B.

The absolute road surface displacement is input from the road surface displacement information reception portion 23 to the memory 21B. Further, the movement distance during one control period is input from the movement distance calculation portion 25 to the memory 21B. The memory 21B records the input road surface displacement information. i.e., the absolute road surface displacement. In this case, the memory 21B records the absolute road surface displacement and the movement distance in association with each other. In other words, the memory 21B includes the road surface profile portion 26, and the displacement (the absolute road surface displacement) and the distance (the movement distance) are stored in the road surface profile portion 26 in association with each other as indicated by the above-described table 1. In other words, the road surface profile portion 26 of the memory 21B records (stores) the absolute road surface displacement for each predetermined distance Ds by which the vehicle 1 moves. The predetermined distance Ds corresponds to the interval at which the absolute road surface displacement is recorded (stored) in the memory 21B (the distance granularity).

A reduction in the predetermined distance Ds leads to an increase in the granularity, thereby bringing about a tendency that the performance of the suspension control (the ride comfort and the running stability) is improved, and a tendency that the memory consumed amount is increased. On the other hand, an increase in the predetermined distance Ds leads to a reduction in the granularity, thereby bringing about a tendency that the performance of the suspension control (the ride comfort and the running stability) is impaired, and a tendency that the memory consumed amount is also reduced. Therefore, the predetermined distance Ds can be set so as to allow the performance of the suspension control (the ride comfort and the running stability) to be secured and the memory consumed amount to be reduced. The predetermined distance Ds may be changed according to an environment surrounding the vehicle. For example, the predetermined distance Ds can be adjusted according to whether the road surface is in a satisfactory condition, whether it is night-time, or whether it is raining. In this case, for example, the predetermined distance Ds can be reduced when the road surface 15 is highly uneven compared to when the road surface 15 is less uneven. The predetermined distance Ds can be set to, for example, approximately 0.5 cm to 2.0 cm.

The road surface profile portion 26 records (stores) the absolute road surface displacement for each predetermined distance Ds based on the movement distance during one control period that is acquired from the movement distance calculation portion 25 and the absolute road surface displacement acquired from the road surface displacement information reception portion 23. The road surface profile portion 26 outputs the recorded (stored) absolute road surface displacement to the suspension control portion 27 when the vehicle 1 moves by the distance L and/or by the distance equivalent to the distance L+the wheelbase W from the measurement point. In other words, the road surface profile portion 26 outputs the tire position road surface displacement (the wheel position road surface displacement information), which is a displacement of the road surface at the position of each of the wheels 3 and 4, to the suspension control portion 27.

The tire position road surface displacement (the wheel position road surface displacement information) is input from the tire position road surface displacement calculation portion 22 (the road surface profile portion 26) to the suspension control portion 27. The suspension control portion 27 calculates the damping force that should be generated by each of the shock absorbers 7 and 10 according to the tire position road surface displacement (the wheel position road surface displacement information). Then, the suspension control portion 27 outputs the control signal (the instruction electric current) according to the damping force that should be generated by each of the shock absorbers 7 and 10 to the shock absorbers 7 and 10, which are control dampers. In other words, the suspension control portion 27 outputs the instruction electric current (the control signal) corresponding to the damper instruction value to the damping force adjustment device of each of the shock absorbers 7 and 10 (for example, the solenoid that adjusts the valve-opening pressure of the damping force adjustment valve).

In this manner, the controller 21 records (stores) the road surface displacement information (the vertical displacement of the road surface) for each predetermined distance Ds by which the vehicle 1 moves into the memory 21B based on the vehicle speed information (the vehicle speed) and the sampling time (the control period). Along therewith, the controller 21 determines the road surface displacement information corresponding to the position of each of the wheels 3 and 4 (the wheel position road surface displacement information) based on the road surface displacement information recorded in the memory 21B. In addition thereto, the controller 21 outputs the instruction electric current (the actuator instruction value) for causing each of the shock absorbers 7 and 10 to perform the predetermined operation according to the determined road surface displacement information (the wheel position road surface displacement information). The predetermined distance Ds based on which the road surface displacement information is recorded into the memory 21B can be changed according to the environment surrounding the vehicle 1 (for example, the road surface condition, night-time, or rainy weather). In this case, the predetermined distance Ds based on which the road surface displacement information is recorded into the memory 21B can be set to, for example, a shorter interval when the road surface 15 is highly uneven compared to when the road surface 15 is less uneven.

Then, the preview sensor 12 detects the road surface displacement information per arbitrarily set predetermined time (the sampling time or the control period). The controller 21 records the road surface displacement information so as to overwrite the immediately preceding road surface displacement information recorded in the memory 21B when the movement distance (ΔD and thus ΣΔD) of the vehicle 1 estimated based on the vehicle speed information and the predetermined time (the sampling time or the control period) is shorter than the predetermined distance Ds. On the other hand, the controller 21 generates interpolation data for interpolating the road surface displacement information between the present road surface displacement information and the immediately preceding road surface displacement information recorded in the memory 21B when the movement distance (ΔD and thus ΣΔD) of the vehicle 1 estimated based on the vehicle speed information and the predetermined time (the sampling time or the control period) is longer than the predetermined distance Ds.

The controller 21 may be configured to record the road surface displacement information updated for each predetermined distance Ds by which the vehicle 1 moves into the memory 21B when the movement speed (the vehicle speed) of the vehicle 1 is equal to or lower than a predetermined speed. In this case, the controller 21 can be configured to, for example, record the road surface displacement information updated for each predetermined time (the sampling time or the control period) into the memory 21B when the movement speed (the vehicle speed) of the vehicle 1 exceeds the predetermined speed.

For example, a vehicle speed at which the movement distance of the vehicle 1 for each predetermined time (for example, one sampling time or one control period) reaches the predetermined distance Ds is set as a vehicle speed threshold value (the predetermined speed). In this case, the controller 21 can record the road surface displacement information updated for each predetermined distance Ds by which the vehicle 1 moves into the memory 21B, for example, when the vehicle speed is lower than the vehicle speed threshold value. On the other hand, the controller 21 can record the road surface displacement information updated for each predetermined time (for each sampling time or each control period) into the memory 21B, for example, when the vehicle speed is higher than the vehicle speed threshold value.

The vehicle control apparatus and the suspension system according to the embodiment are configured in the above-described manner, and the operation thereof will be described next.

The preview sensor 12 provided on the front portion of the vehicle body 2 images the road surface 15 lying ahead of the vehicle 1 as road surface preview information (the road surface displacement information), and outputs it to the controller 21. The controller 21 variably controls the damping force that should be generated by each of the shock absorbers 7 and 10 based on the road surface displacement information output from the preview sensor 12 and the vehicle information output from the vehicle speed sensor 11.

In this case, every time the vehicle 1 moves by the predetermined distance Ds, the controller 21 stores (records) the road surface displacement information at that time into the memory 21B while acquiring the road surface displacement information into the memory 21B per predetermined sampling period. Due to that, the granularity of the road surface displacement information (the distance length) stored in the memory 21B of the controller 21 can be designed so as to be kept constant. As a result, the memory capacity can be constant regardless of the speed of the vehicle 1 (the vehicle speed). Further, the input from the preview sensor 12 does not have to be converted into time, and therefore the processing can be simplified and an error reduction can be achieved.

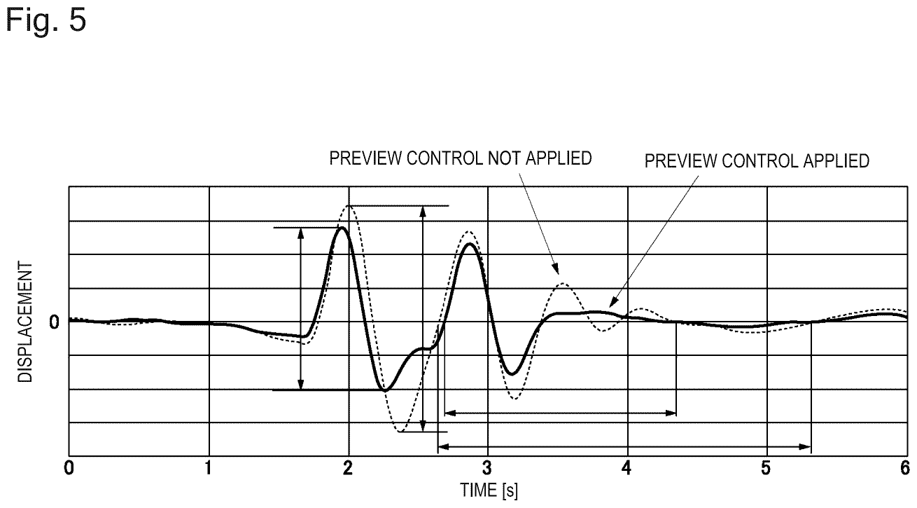

FIG. 5 illustrates an effect of the control of the semi-active suspension system according to the embodiment. In other words, FIG. 5 illustrates one example of a change in the displacement of the vehicle 1 over time according to the embodiment. This FIG. 5 illustrates when the vehicle 1 runs on a bump (a bump road) at a low speed of 10 km/h. The embodiment can reduce the floor vertical displacement by 20% and an aftershock duration by 32% with the aid of the preview control compared to when the preview control is absent.

In this manner, in the embodiment, the controller 21 records the road surface displacement information into the memory 21B for each predetermined distance Ds by which the vehicle 1 moves based on the vehicle speed information and the sampling time (the control period), and also determines the wheel position road surface displacement information corresponding to the position of each of the wheels 3 and 4 based on this road surface displacement information recorded in this memory 21B. Therefore, the road surface displacement information can be recorded into the memory 21B at granularity (data detailedness) according to the distance. Due to that, the road surface displacement information can be recorded into the memory 21B by a constant amount (memory consumed amount) regardless of the vehicle speed.

As a result, considerable memory consumption can be avoided at the time of a low speed. Further, for example, the memory consumed amount can be easily estimated at a design stage. In addition, the road surface displacement information is recorded for each predetermined distance Ds, and therefore the controllability of the vehicle 1, i.e., the ride comfort and the running stability due to the operation of the shock absorbers 7 and 10 can be secured by setting this predetermined distance Ds within a range capable of ensuring a desired suspension performance. Especially, at the time of a low speed, the movement distance reduces, and therefore the granularity (the precision) of the road surface displacement (the road surface profile) can be secured and the controllability can be improved while the memory consumed amount is reduced. As a result, both the “securement of the performance (the ride comfort and the running stability)” and the “reduction in the memory consumed amount” can be achieved at the same time.

According to the embodiment, the predetermined distance Ds based on which the road surface displacement information is recorded into the memory 21B is changed according to the environment surrounding the vehicle 1. Therefore, for example, the controllability when the road surface is ill-conditioned can be improved by reducing the predetermined distance Ds when the road surface is ill-conditioned. Further, for example, the night-time controllability can be improved and the nigh-time ride comfort can be improved by reducing the predetermined distance Ds at night-time. Further, for example, the controllability when it rains can be improved and the running stability when it rains can be improved by reducing the predetermined distance Ds when it rains.

According to the embodiment, the predetermined distance Ds based on which the road surface displacement information is recorded into the memory 21B is set to a shorter interval when the road surface 15 is highly uneven compared to when the road surface 15 is less uneven. Therefore, the controllability can be improved when the road surface 15 is highly uneven compared to when the road surface 15 is less uneven. As a result, the ride comfort and the running stability can be improved when the road surface 15 is highly uneven.

According to the embodiment, the preview sensor 12 detects the road surface displacement information per arbitrarily set predetermined time (the sampling time). In addition thereto, the controller 21 overwrites the immediately preceding road surface displacement information recorded in the memory 21B when the movement distance (ΔD and thus ΣΔD) of the vehicle 1 estimated based on the vehicle speed information and the predetermined time (the sampling time) is shorter than the predetermined distance Ds. Therefore, the immediately preceding road surface displacement information is overwritten until the movement distance (ΔD and thus ΣΔD) reaches the predetermined distance Ds, and the latest road surface displacement information is recorded into the memory 21B when the movement distance (ΔD and thus ΣΔD) reaches the predetermined distance Ds. As a result, the road surface displacement information for each predetermined distance Ds can be recorded while the memory consumption is reduced.

According to the embodiment, the preview sensor 12 detects the road surface displacement information per arbitrarily set predetermined time (the sampling time). In addition thereto, the controller 21 generates the interpolation data for interpolating the road surface displacement information between the detected road surface displacement information and the immediately preceding road surface displacement information recorded in the memory 21B when the movement distance (ΔD and thus ΣΔD) of the vehicle 1 estimated based on the vehicle speed information and the predetermined time (the sampling time) is longer than the predetermined distance Ds. Therefore, when the vehicle runs at a high speed, the granularity (the precision) of the road surface displacement (the road surface profile) can be secured due to the recorded road surface displacement information and the interpolation data even when the road surface displacement information cannot be recorded for each predetermined distance Ds.

Then, as the interpolation data, for example, the road surface displacement information can be linearly interpolated using the road surface displacement information in the previous control period and the road surface displacement information in the present control period. When the linear interpolation is applied, the error may increase, for example, when the vehicle 1 runs at a high speed on the road surface 15 where a large difference lies in the displacement of the road surface. However, the vehicle 1 is expected to run while slowing down the speed when running on the road surface 15 conditioned in this manner, and therefore the error due to the interpolation can be deemed allowable.

According to the embodiment, the controller 21 records the road surface displacement information for each predetermined distance Ds by which the vehicle 1 moves into the memory 21B when the movement speed (the vehicle speed) of the vehicle 1 is equal to or lower than the predetermined speed. Therefore, when the movement speed of the vehicle 1 is equal to or lower than the predetermined speed, the granularity (the precision) of the road surface displacement (the road surface profile) can be secured while the memory consumed amount is reduced by recording the road surface displacement information into the memory 21B for each predetermined distance Ds. On the other hand, when the movement speed of the vehicle 1 is higher than the predetermined speed, the granularity (the precision) of the road surface displacement (the road surface profile) can be secured and the memory consumed amount can also be reduced by, for example, recording the road surface displacement information into the memory 21B for each predetermined time (for example, one sampling time).

The embodiment has been described citing the example in which the vehicle control apparatus and the suspension system are configured to record the road surface displacement information into the memory 21B of the controller 21, which controls the shock absorbers 7 and 10. However, without being limited thereto, the vehicle control apparatus and the suspension system may be configured to, for example, record the road surface displacement information into a memory provided separately from the controller 21, which controls the shock absorbers 7 and 10 (for example, a memory of another controller). In this case, the vehicle control apparatus and the suspension system can be configured to, for example, output the tire position road surface displacement (the wheel position road surface displacement information) based on the road surface displacement information recorded in the memory provided separately from the controller to the suspension control portion.

The embodiment has been described citing the example in which the preview sensor 12 works as the road surface displacement portion that detects the road surface displacement information in the traveling direction of the vehicle 1. However, without being limited thereto, the road surface detection portion may be, for example, a laser displacement meter. In other words, the vehicle control apparatus and the suspension system may be configured to, for example, include the laser displacement meter provided so as to face the road surface 15 below (inside) the front bumper located on the front side with respect to the front wheel 3 of the vehicle 1, and detect the displacement (the vertical displacement) of the road surface 15 facing this laser displacement meter. In this case, a measured relative road surface displacement is changed according to a pitch and a roll of the vehicle body 2 of the vehicle 1.

In light thereof, in this case, the absolute road surface displacement is determined by calculating a displacement derived from the pitch and the roll of the vehicle body 2 using an acceleration sensor (a G sensor) mounted on the vehicle body 2, and removing it from a value measured (a value detected) by the laser displacement meter. Then, the determined absolute road surface displacement is recorded (registered) into the memory 21B of the controller 21 for each predetermined distance Ds and is output at the position of each of the wheels 3 and 4, which corresponds to the tire position, similarly to the above-described embodiment. As a result, the shock absorbers 7 and 10 can be controlled in a similar manner to the above-described embodiment.

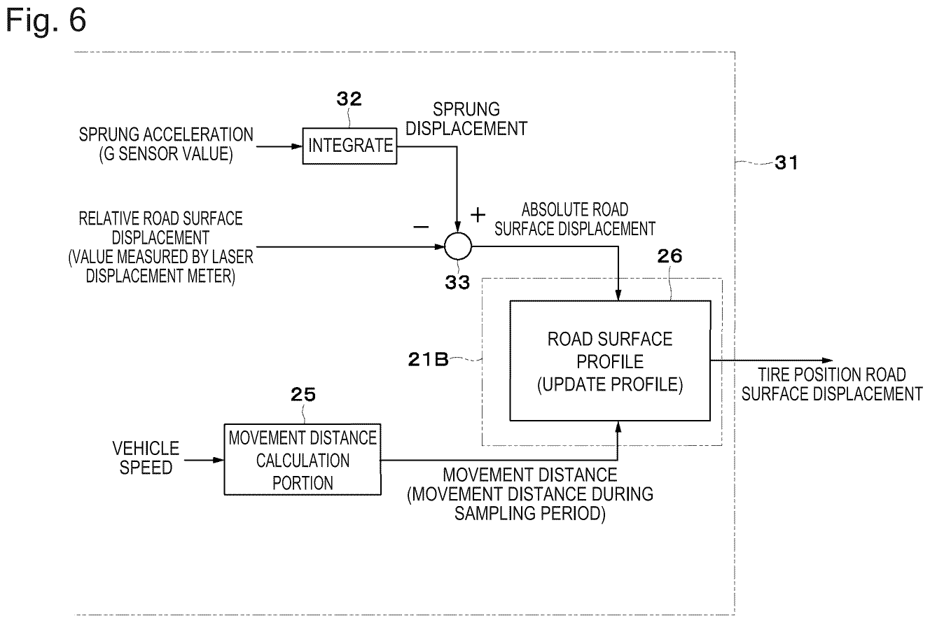

FIG. 6 illustrates a tire position road surface displacement calculation portion 31 of the controller 21 according to a modification. The vehicle speed sensor value (the vehicle speed information) acquired from the vehicle speed sensor 11, the measured value (the road surface displacement information) acquired from the laser displacement meter, and an acceleration sensor value (acceleration information) acquired from the acceleration sensor are input to the tire position road surface calculation portion 31. The measured value acquired from the laser displacement meter corresponds to the relative displacement amount of the road surface, i.e., the relative road surface displacement. The acceleration sensor value acquired from the acceleration sensor corresponds to a sprung acceleration.

The tire position road surface calculation portion 31 calculates the displacement of the road surface 15 at the position of each of the wheels 3 and 4, i.e., the tire position road surface displacement (the wheel position road surface displacement information) based on the vehicle speed sensor value (the vehicle speed information), the value measured by the laser displacement meter (the road surface displacement information), and the sensor value of the acceleration sensor (the acceleration information). The tire position road surface displacement calculation portion 31 outputs the calculated tire position road surface displacement (the wheel position road surface displacement information) to the suspension control portion 27.

The tire position road surface calculation portion 31 includes an integration portion 32, a subtraction portion 33, the movement distance calculation portion 25, and the memory 21B (the road surface profile portion 26). Further, the tire position road surface displacement calculation portion 31 according to the modification also includes a road surface displacement information reception portion to which the value measured by the laser displacement meter (the road surface displacement information) is input, and the vehicle speed information reception portion 24 to which the vehicle speed sensor value of the vehicle speed sensor 11 (the vehicle speed information) is input (refer to FIG. 2), although they are omitted in FIG. 6.

The sprung acceleration (the acceleration information), which is the sensor value of the acceleration sensor, is input to the integration portion 32. The integration portion 32 calculates the sprung displacement by integrating the sprung acceleration, and outputs the calculated sprung displacement to the subtraction portion 33. The relative road surface displacement (the road surface displacement information), which is the value measured by the laser displacement meter, and the sprung displacement (sprung displacement information), which is the value calculated by the integration portion 32, are input to the subtraction portion 33.

The subtraction portion 33 calculates the absolute road surface displacement by subtracting the relative road surface displacement from the sprung displacement. The relative road surface displacement corresponds to the distance between the sprung side and the road surface, and therefore “the absolute road surface displacement=the sprung displacement−(the sprung displacement−the road surface)” is established. The subtraction portion 33 outputs the calculated absolute road surface displacement to the memory 21B (the road surface profile portion 26). The memory 21B (the road surface profile portion 26) and the movement distance calculation portion 25 are similar to the above-described embodiment, and therefore the descriptions thereof will be omitted here.

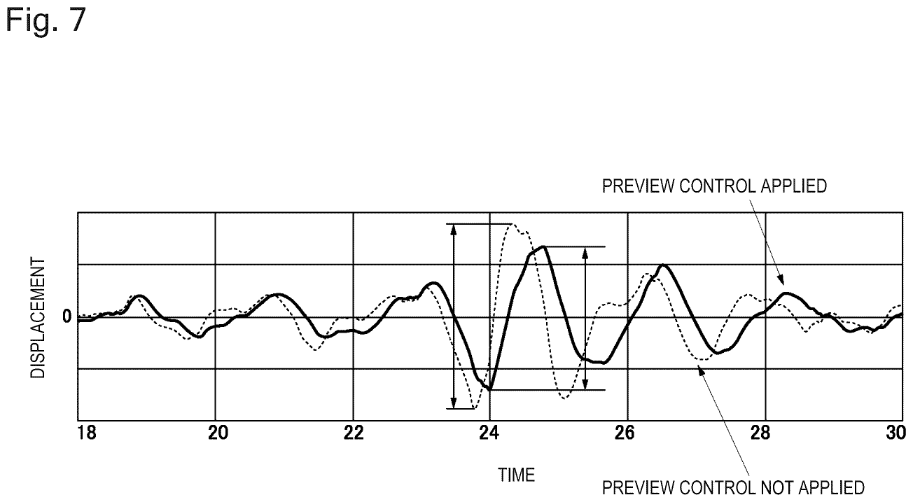

FIG. 7 illustrates an effect of control of an active suspension system according to a modification. In other words, FIG. 7 illustrates one example of a change in the displacement of the vehicle 1 over time according to the modification. This FIG. 7 illustrates when the vehicle 1 runs on a bump road (a bump) at 50 km/h. The modification can reduce the floor vertical displacement by 23% with the aid of the preview control (laser displacement control). In other words, the modification can also achieve both the “securement of the performance (the ride comfort and the running stability)” and the “reduction in the memory consumed amount” at the same time, similarly to the above-described first embodiment.

The above-described embodiment has been described citing the example in which the preview sensor 12 is used as the road surface displacement detection portion in charge of the preview control. Further, the modification has been described citing the example in which the laser displacement meter is used as the road surface displacement detection portion in charge of the preview control. However, without being limited thereto, the road surface displacement detection portion in charge of the preview control may be embodied by using, for example, a monocular camera, a lidar (LiDAR), or map information. In other words, the road surface displacement detection portion can be embodied using any of various kinds of road surface displacement information providing devices capable of providing the road surface information in the traveling direction of the vehicle.

Next, a function enabled by storing the distance and the displacement information in the memory 21B in association with each other will be described. In the preview control using the road surface displacement information, it is considered that the performance may be impaired due to insufficient measurement granularity, noise of a sensor signal, or the like depending on the road surface condition and the surrounding environment. In light thereof, for the road surface condition, the frequency of the road surface is predicted based on the road surface profile in the memory 21B, and the distance granularity, i.e., the predetermined distance Ds is changed according to the road surface frequency. In this case, for example, the distance granularity can be raised (the predetermined distance Ds can be reduced) when the road surface has a high frequency, and can be lowered (the predetermined distance Ds can be increased) when the road surface has a low frequency. As a result, optimum control according to the road surface condition can be performed.

On the other hand, for the influence of the surrounding environment, the consistency between previously measured data and presently measured data can be confirmed and/or corrected in a case where the preview sensor 12 conducts the measurement while covering a predetermined width in the traveling direction of a predetermined vehicle. More specifically, the vehicle 1 may be under an environment disadvantageous for the detection of the road surface displacement information depending on the environment surrounding the vehicle 1. For example, in the case where the laser displacement meter is used, it is considered that the performance may be impaired when the vehicle 1 is under weather that causes sunlight noise, or the vehicle 1 runs on a road surface having a shape or made from a material where laser light cannot be reflected well. On the other hand, in the case where the camera is used, it is considered that the performance may be impaired when it is not sufficiently blight or it is foggy.

In light thereof, the consistency of the presently measured data is confirmed and/or corrected based on the previously measured data in such a case. More specifically, the same location of the road surface 15 is sampled a plurality of times w % ben the preview sensor 12 in use measures the predetermined width in the traveling direction of the vehicle 1. At this time, the previously sampled road surface displacement and distance, the presently sampled road surface displacement and distance, and the distance by which the vehicle 1 moves during the sampling interval can be identified, and therefore the consistency with the previous value can be confirmed and/or the data can be corrected. As a result, optimum control can be achieved even when the surrounding environment is disadvantageous for the detection of the road surface displacement information.

According to the above-described embodiment, the vehicle control apparatus records the road surface displacement information into the memory for each predetermined distance by which the vehicle moves based on the vehicle speed information and the sampling time, and also determines the wheel position road surface displacement information corresponding to the position of the wheel based on this road surface displacement information recorded in this memory. Therefore, the road surface displacement information can be recorded into the memory at granularity (data detailedness) according to the distance. Due to that, the road surface displacement information can be recorded into the memory by a constant amount (memory consumed amount) regardless of the vehicle speed. As a result, considerable memory consumption at the time of a low speed can be avoided. Further, for example, the memory consumed amount can be easily estimated at a design stage. In addition, the road surface displacement information is recorded for each predetermined distance, and therefore the controllability of the vehicle, i.e., the ride comfort and the running stability due to the operation of the actuator apparatus can be secured by setting this predetermined distance within a range capable of ensuring a desired performance. Especially, at the time of a low speed, the movement distance reduces, and therefore the granularity (the precision) of the road surface displacement (the road surface profile) can be secured and the controllability can be improved while the memory consumed amount is reduced. As a result, both the “securement of the performance (the ride comfort and the running stability)” and the “reduction in the memory consumed amount” can be achieved at the same time.

According to the embodiment, the predetermined distance based on which the road surface displacement information is recorded into the memory is changed according to the environment surrounding the vehicle. Therefore, for example, the controllability when the road surface is ill-conditioned can be improved by reducing the predetermined distance when the road surface is ill-conditioned. Further, for example, the night-time controllability can be improved and the night-time ride comfort can be improved by reducing the predetermined distance at night-time. Further, for example, the controllability when it rains can be improved and the running stability when it rains can be improved by reducing the predetermined distance when it rains.

According to the embodiment, the predetermined distance based on which the road surface displacement information is recorded into the memory is set to a shorter interval when the road surface is highly uneven compared to when the road surface is less uneven. Therefore, the controllability can be improved when the road surface is highly uneven compared to when the road surface is less uneven. As a result, the ride comfort and the running stability can be improved when the road surface is highly uneven.

According to the embodiment, the road surface displacement detection portion detects the road surface displacement information per arbitrarily set predetermined time. In addition thereto, the vehicle control apparatus overwrites the immediately preceding road surface displacement information recorded in the memory when the movement distance of the vehicle estimated based on the vehicle speed information and the predetermined time is shorter than the predetermined distance. Therefore, the immediately preceding road surface displacement information is overwritten until the movement distance reaches the predetermined distance, and the latest road surface displacement information is recorded into the memory when the movement distance reaches the predetermined distance. As a result, the road surface displacement information for each predetermined distance can be recorded while the memory consumption is reduced.

According to the embodiment, the road surface displacement detection portion detects the road surface displacement information per arbitrarily set predetermined time. In addition thereto, the vehicle control apparatus generates the interpolation data for interpolating the road surface displacement information between the detected road surface displacement information and the immediately preceding road surface displacement information recorded in the memory when the movement distance of the vehicle estimated based on the vehicle speed information and the predetermined time is longer than the predetermined distance. Therefore, when the vehicle runs at a high speed, the granularity (the precision) of the road surface displacement (the road surface profile) can be secured due to the recorded road surface displacement information and the interpolation data even when the road surface displacement information cannot be recorded for each predetermined distance.

According to the embodiment, the vehicle control apparatus records the road surface displacement information for each predetermined distance by which the vehicle moves into the memory when the movement speed of the vehicle is equal to or lower than the predetermined speed. Therefore, when the movement speed of the vehicle is equal to or lower than the predetermined speed, the granularity (the precision) of the road surface displacement (the road surface profile) can be secured while the memory consumed amount is reduced by recording the road surface displacement information into the memory for each predetermined distance. On the other hand, when the movement speed of the vehicle is higher than the predetermined speed, the granularity (the precision) of the road surface displacement (the road surface profile) can be secured and the memory consumed amount can also be reduced by, for example, recording the road surface displacement information into the memory for each sampling time.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-008595 filed on Jan. 24, 2022. The entire disclosure of Japanese Patent Application No. 2022-008595 filed on Jan. 24, 2022 including the specification, the claims, the drawings, and the abstract is incorporated herein by reference in its entirety.

### REFERENCE SIGNS LIST

1 vehicle
2 vehicle body
3 front wheel (wheel)
4 rear wheel (wheel)
7, 10 damping force adjustable shock absorber (actuator apparatus)
11 vehicle speed sensor (vehicle speed information output portion)
12 preview sensor (road surface displacement detection portion)
15 road surface
21 controller (vehicle control apparatus)
21A control portion
21B memory
23 road surface displacement information reception portion
24 vehicle speed information reception portion
Ds predetermined distance (predetermined distance)

1. A vehicle control apparatus mounted on a vehicle, the vehicle including
an actuator apparatus provided between a vehicle body and a wheel of a vehicle and configured to change a force for suppressing a relative displacement between the vehicle body and the wheel,
a road surface displacement detection portion configured to detect road surface displacement information in a traveling direction of the vehicle, and
a vehicle speed information output portion configured to output vehicle speed information of the vehicle,
the vehicle control apparatus being configured to control the actuator apparatus, the vehicle control apparatus comprising:
a road surface displacement information reception portion configured to receive an input of the road surface displacement information;
a vehicle speed information reception portion configured to receive an input of the vehicle speed information; and
a memory configured to record the input road surface displacement information,
wherein the vehicle control apparatus records the road surface displacement information into the memory for each predetermined distance by which the vehicle moves based on the vehicle speed information and a sampling time and also determines wheel position road surface displacement information corresponding to a position of the wheel based on the road surface displacement information recorded in the memory, and outputs an actuator instruction value for causing the actuator apparatus to perform a predetermined operation according to the wheel position road surface displacement information, and
wherein the predetermined distance based on which the road surface displacement information is recorded into the memory can be changed to be a shorter interval when a road surface is highly uneven compared to when the road surface is less uneven.

2. The vehicle control apparatus according to claim 1, wherein the predetermined distance based on which the road surface displacement information is recorded into the memory is changed according to an environment surrounding the vehicle.

3. (canceled)

4. The vehicle control apparatus according to claim 1, wherein the road surface displacement detection portion detects the road surface displacement information per arbitrarily set predetermined time, and
wherein the road surface displacement information is recorded so as to overwrite immediately preceding road surface displacement information included in the road surface displacement information recorded in the memory when a movement distance of the vehicle estimated based on the vehicle speed information and the predetermined time is shorter than the predetermined distance.

5. The vehicle control apparatus according to claim 1, wherein the road surface displacement detection portion detects the road surface displacement information per arbitrarily set predetermined time, and
wherein interpolation data for interpolating the road surface displacement information between the detected road surface displacement information and the immediately preceding road surface displacement information recorded in the memory is generated when the movement distance of the vehicle estimated based on the vehicle speed information and the predetermined time is longer than the predetermined distance.

6. The vehicle control apparatus according to claim 1, wherein the road surface displacement information for each predetermined distance by which the vehicle moves is recorded into the memory when a movement speed of the vehicle is equal to or lower than a predetermined speed.

7. A suspension system comprising:
an actuator apparatus provided between a vehicle body and a wheel of a vehicle and configured to change a force for suppressing a relative displacement between the vehicle body and the wheel;
a road surface displacement detection portion configured to detect road surface displacement information in a traveling direction of the vehicle;
a vehicle speed information output portion configured to output vehicle speed information of the vehicle;
a memory configured to record the road surface displacement information; and
a vehicle control apparatus configured to record the road surface displacement information into the memory for each predetermined distance by which the vehicle moves based on the vehicle speed information and a sampling time and also determine wheel position road surface displacement information corresponding to a position of the wheel based on the road surface displacement information recorded in the memory, and output an actuator instruction value for causing the actuator apparatus to perform a predetermined operation according to the wheel position road surface displacement information,
wherein the vehicle control apparatus can change the predetermined distance based on which the road surface displacement information is recorded into the memory to be a shorter interval when a road surface is highly uneven compared to when the road surface is less uneven.
